(19) United States
(12) Patent Application Publication
(10) Pub. No.: US 2018/0231211 A1
(43) Pub. Date: Aug. 16, 2018

(54) Novel Reflector Lighting Fixtures

(71) Applicant: Nulite Lighting, Denver, CO (US)

(72) Inventor: Brian Beck, Denver, CO (US)

(73) Assignee: Nulite Lighting, Denver, CO (US)

(21) Appl. No.: 15/872,970

(22) Filed: Jan. 16, 2018

Related U.S. Application Data
(60) Provisional application No. 62/447,421, filed on Jan. 17, 2017.

(51) Int. Cl. F21V 7/00; F21V 7/22

(52) U.S. Cl. CPC F21V 7/0016; F21Y 2115/10; F21V 7/22; F21V 7/0025

(57) ABSTRACT

Lighting fixtures with one or more reflectors, paired with a lighting source providing indirect light from one or more apertures in one sphere above or below the system and direct light from one or more apertures in another sphere above or below the system providing efficient lighting for various uses is described.

### RELATED APPLICATIONS

This application claims the benefit of U.S. Provisional application No. 62/447,421 titled “Novel Reflector Lighting Fixtures” filed Jan. 17, 2017 which is incorporated herein by reference.

### BACKGROUND OF THE INVENTION

Current LED general lighting fixtures require the use of optical diffusers to both direct light in the appropriate distribution for a given task, and prevent glare in the visual field of users from direct exposure to intense light sources. Optical diffusers employed can decrease the efficiency of the light fixtures, and add expense and complication to the overall fixture.

There is a need for developing novel and efficient lighting fixtures improving their efficiency, cost, and maintenance.

### SUMMARY OF THE INVENTION

Lighting fixtures comprising one or more complimentary reflectors paired with a lighting source provide direct light from one or more apertures in a sphere above or below the system and indirect light from one or more apertures in another sphere above or below the system without the use of an optical diffuser. The lighting fixtures can be used as linear suspended fixtures, surface mounted fixtures, recessed fixtures and the like made from various materials that maintain their shape under ambient conditions for which the system is purposed.

### BRIEF DESCRIPTION OF DRAWINGS

FIG. 1. A reflector lighting fixture bearing bottom and top aperture reflectors.

FIG. 2. Fixture housing with different reflectors and external shape options for direct and indirect lighting.

### DETAILED DESCRIPTION OF THE INVENTION

A novel lighting system employing one or more complimentary reflecting surfaces to provide efficient reduced glare illumination is provided.

In one embodiment, there is described a lighting system bearing complimentary reflectors paired with one or more lighting sources to provide direct light and indirect light.

In another embodiment, there is described a lighting system bearing complimentary reflectors paired with one or more lighting sources to provide direct light and indirect light, without the use of optical diffuser.

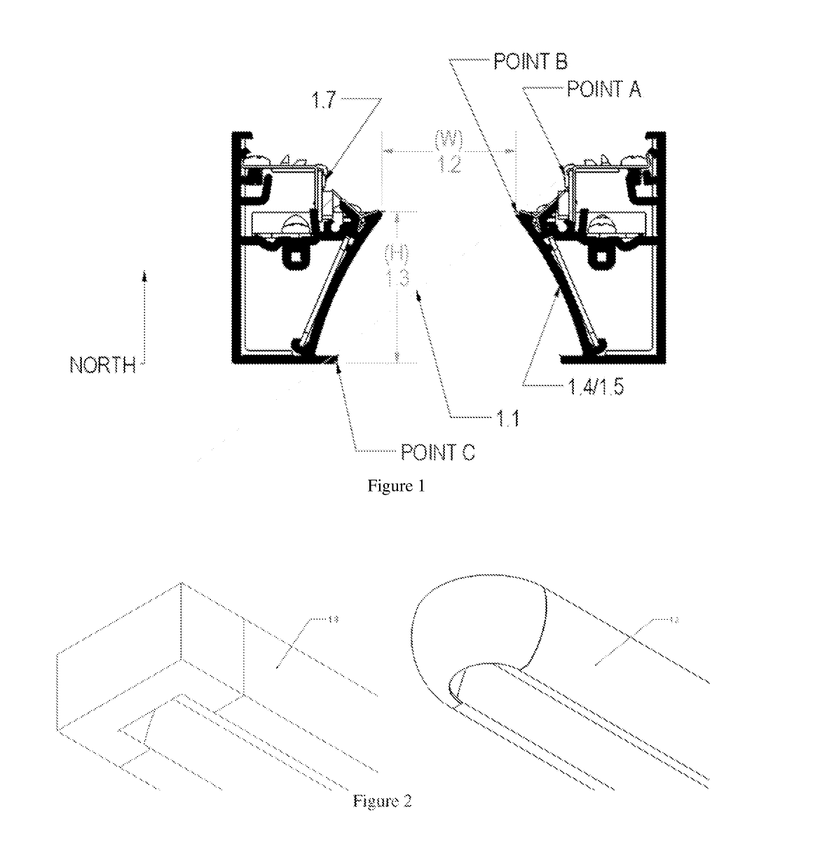

FIG. 1 shows an embodiment of the reflector lighting system bearing a bottom aperture [1.1], the reflector body [1.4]. bearing a finish or reflector surface [1.5] with a reflector shape [1.5] which is variable based on the desired direct distribution of the direct portion of the light, the lighting source [1.7] such as a LED is attached so that lighting is aimed horizontally [1.7] (+/−20 degrees) and optional external reflective surface such as a wall, building surface or a shroud attached to the reflector system.

In one embodiment, a lighting fixture is described with one or more reflectors, paired with a lighting source providing direct light from an aperture in one sphere above or below the system and indirect light from an aperture in another sphere above or below the system. In one embodiment, a lighting fixture has one or more reflectors, paired with a lighting source providing direct light from an aperture in one sphere above or below the system and indirect light from an aperture in another sphere above or below the system without the use of an optical diffuser. In one embodiment the light source might be a single point, a plurality of points such as a row in a straight line, a circle or other geometric pattern or a surface that is flat, convex, concave or bearing other angular or curved surfaces that emits light.

In one embodiment, a reflector system made of various materials, paired with a lighting source provides direct light from apertures in multiple spheres around the system and indirect light from apertures in other spheres around the system without the use of an optical diffuser. The lighting systems are fixtures which are linear suspended fixtures, surface mounted fixtures, recessed fixtures and the like.

In one embodiment, a reflector system made of various materials, paired with a lighting source provides direct light from apertures in multiple spheres around the system and indirect light from apertures in other spheres around the system with the use of an optical diffuser.

The lighting systems are fixtures which are linear suspended fixtures, surface mounted fixtures, recessed fixtures and the like.

The light source for the lighting fixtures may be a LED, OLED, laser, fluorescent, incandescent, and other light source.

The power to the light source may be stored on the fixture in a battery, conveyed via a cable or other means. The light source might be controlled via a cable or remote control to turn on and off and vary its intensity.

The light source, power supply means and controlling means and components of the lighting system of the present invention may be assembled and connected to the reflector using fasteners, glue, tape or be integral to one another. The system may be put together using means of assembly and manufacturing known in the art.

The reflecting surface components can be made from various materials that maintain their shape under conditions for which the system is purposed. Materials employed may include metals such as aluminum, magnesium alloys, steel and the like; synthetic polymers such as polyacetals, polycarbonates, nylons, polyesters, acrylonitrile butadiene styrene (ABS) materials, polypropylene, HDPE, polyurethanes and the like; natural polymers such as wood, silk, cotton, etc. Other materials such as carbon fiber materials, composites, glass, ceramics or plastics and like materials may be used to fabricate the components of the system.

In one embodiment, the reflector has a diffuse finish. In another embodiment the reflector has a specular finish.

In one embodiment, the reflector surface on the light fixture can be adjusted so that direct light from the light source is incident on a surface providing a fixture that can provide both direct and diffused light by making adjustments to it.

In another embodiment, the light source is moved so that incident light emitted by the source is incident directly on the objects below the light fixture thus bypassing the reflector or reflectors. This operation mode is an alternative use for the light fixture when more intense or direct light is needed.

The surface of the reflector may have a finish ranging from 100% diffuse to 100% specular, and could be applied in a secondary process to the reflector body.

In various embodiments, the shape of the reflectors employed in the system is configured based on the desired direct and indirect illumination from the system.

In various embodiments, the shape of the reflectors employed in the system is configured based on the desired direct and indirect illumination from the system with inclusion of optical diffusers as needed.

In other embodiments of the invention reflectors of different shapes including flat facets, circular arcs, and parabolic arcs are employed.

The system components may be fabricated by various processes known in art to make components including extrusion, injection molding, stamping, cold forming and like industrial methods and other methods such as 3D printing, hand crafting and the like.

In one embodiment the invention is a novel lighting system employing complimentary reflecting surfaces to provide direct light in one or more planes and indirect light in a different plane or planes.

The lighting fixtures of the present invention may use incandescent, fluorescent, OLED, LED and like lighting which uses electrical power supply known to one of ordinary skill in the art.

The lighting fixtures of the present invention preferable use LED lighting which uses electrical power supply known to one of ordinary skill in the art.

In one embodiment, a reflector system is made of various materials, paired with various lighting sources to provide direct light (from bottom aperture) and indirect light (from top aperture) output, without the use of any optical diffuser.

In one embodiment, a reflector system provides reflecting surfaces that provide direct reflected light in a sphere below the system with full cutoff of the lighting source. The system controls glare and removes the need for an optical diffuser.

In other embodiments the dimensions of a reflector on the direct light producing surface of the lighting system can bear various dimensions and shapes as long cutoff is maintained.

A diffuser is any device that diffuses or spreads out or scatters light in some manner, to give soft light.

A reflective diffuser reflects diffusely from a white surface or lightly colored surface

An optical diffuser is typically required in a lighting fixture to tone down the intensity of the lighting source for personal comfort reasons. By removing the optical diffuser, the light fixture is able to light the space more efficiently.

A diffuser is any device that diffuses or spreads out or scatters light in some manner, to give soft light.

A reflective diffuser reflects diffusely from a white or colored surface.

An optical diffuser converts the incident light beam into a cluster of scattered rays. When a diffuser is placed in front if an object, we can only view a blurred image such as frosted plastic or glass. An optical diffuser is basically a refractive element with a random surface profile.

In one embodiment, FIG. 1 shows a lighting fixture laid out such that there is full cutoff of the lighting source from the bottom aperture [1.1]. A line drawn from point A to point B representing a beam of light from a light source needs to always land on or above point C. This removes the need for an optical diffuser, which is normally a type of frosted plastic or glass. The width [1.2] of the bottom aperture and height [1.3] of the reflector may increase or decrease as long as cutoff is maintained. The reflector body [1.4] could be any material that maintains its form at ambient conditions or room temperature. The finish [1.5] of the reflector can range from 100% diffuse to 100% specular.

The finish to the reflector can be applied in a secondary process to the reflector body.

An optical diffuser is typically required in a lighting fixture to tone down the intensity of the lighting source for personal comfort reasons. By removing the optical diffuser, the light fixture is able to light the space more efficiently.

An optical diffuser converts the incident light beam into a cluster of scattered rays. When a diffuser is placed in front if an object, we can only view a blurred image such as frosted plastic or glass. An optical diffuser is basically a refractive element with a random surface profile.

The shape of the reflector [1.5] is variable based on the desired distribution of the direct portion of the light.

The angle of the reflector [1.5] is variable based on the desired distribution of the direct portion of the light.

The outside of the fixture [1.8] is variable based on aesthetic desires. See FIG. 2 for options

The lighting source [1.7] is attached to the reflector system such that the lighting source is aimed horizontally [8] (+/−20 degrees). This provides enough light to enter the reflector system and exit the bottom aperture (at least 10% of total fixture), while maintaining a distribution out of the indirect aperture that maintains uniformity across the external reflective surface (if one exists).

An external reflective surface could be a building surface, or a shroud attached to the reflector system.

The fixture is powered by a driver power supply to be located away from the lighting source/reflector system. The power supply varies based on the lighting source.

What is claimed is:

1. A lighting fixture, comprising:
A light source and one or more complimentary reflector surfaces configured to fully obfuscate the lighting source and to provide indirect light from one hemisphere and direct light form an opposite hemisphere without using an optical diffuser.

2. The lighting fixture of claim 1 where, reflectors paired with a LED lighting source to provide direct light and indirect light, without the use of optical diffuser.

3. The lighting fixture of claim 1 where, the fixtures are linear suspended fixtures, surface mounted fixtures, recessed fixtures.

4. The lighting fixture of claim 1 where, the fixture is made from various materials that maintain their shape under ambient conditions for which the system is purposed.

5. The lighting fixture of claim 1 where, materials employed for fabrication of the light fixture are selected metals such as aluminum, magnesium alloys, steel and the like; synthetic polymers such as polyacetals, polycarbonates, nylons, polyesters, acrylonitrile butadiene styrene (ABS) materials, polypropylene, HDPE, polyurethanes and the like; natural polymers such as wood, silk, cotton, etc. Other materials such as carbon fiber materials, composites, glass, ceramics or plastics and the like materials may be used to fabricate the components of the system.

6. The lighting fixture of claim 1 where, the reflector has a diffuse finish.

7. The lighting fixture of claim 1 where, the reflector has a specular finish.

8. The lighting fixture of claim 1 where, the surface of the reflector may have a finish ranging from 100% diffuse to 100% specular, and could be applied in a secondary process to the reflector body.

9. The lighting fixture of claim 1 where, the shape of the reflectors employed in the system is configured based on the desired distribution of the direct portion of the light.

10. The lighting fixture comprising;
a reflector paired with a LED lighting source which provides direct light from an aperture in one sphere above or below the system and indirect light from an aperture in another sphere above or below the system.

11. The lighting fixture of claim 10 where, a plurality of reflectors paired with one or more lighting sources provide direct light from apertures in multiple spheres around the system and indirect light from apertures to other spheres around the system.

12. A lighting fixture of claim 11 where reflecting surfaces positioned in relation to the light source so that there is complete cutoff and glare free direct illumination from the light source.

13. A lighting fixture of claim 11 where indirect light from a reflection of light directly of the light source on surrounding ambient surfaces.

14. The lighting fixture of claim 13 where said light source is selected from a LED, fluorescent and incandescent.

15. The lighting fixture of claim 13 where said a reflector system is made of various materials, paired with various lighting sources to provide direct light (from bottom aperture) and indirect light (from top aperture) output, without the use of any diffuser.

16. The lighting fixture of claim 13 where dimensions of a reflector on the direct light producing surface of the lighting system can bear various dimensions and shapes as long cutoff is maintained.

17. The lighting fixture of claim 10 where, the reflector has a diffuse finish.

18. The lighting fixture of claim 10 where, the reflector has a specular finish.

19. The lighting fixture of claim 10 where, the surface of the reflector may have a finish ranging from 100% diffuse to 100% specular, and could be applied in a secondary process to the reflector body.
